(19) United States
(12) Patent Application Publication
(10) Pub. No.: US 2019/0204168 A1
(43) Pub. Date: Jul. 4, 2019

(54) SELF-CONFIGURING MODULAR SURFACE SENSORS ANALYTICS SYSTEM

(71) Applicant: Scanalytics, Inc., Milwaukee, WI (US)

(72) Inventors: Joseph Scanlin, Milwaukee, WI (US); David M. Webber, Madison, WI (US)

(21) Appl. No.: 16/234,194

(22) Filed: Dec. 27, 2018

Related U.S. Application Data
(60) Provisional application No. 62/612,959, filed on Jan. 2, 2018.

(51) Int. Cl. G01L 1/22; G05B 19/042

(52) U.S. Cl. CPC G01L 1/2206; G05B 2219/23227; G05B 19/042; G01L 1/225

(57) ABSTRACT

In some embodiments, a method of controlling a self-configuring sensor array includes receiving a plurality of contact signals from the plurality of respective contact sensors. In some embodiments, the method further includes generating one or more paths based on a temporal relationship amongst the plurality of contact signals. In some embodiments, the generating is further based on a spatial relationship between the respective contact sensors. In some embodiments, the method further includes generating a first entity profile based on the one or more paths. In some embodiments, the method includes generating a tile map based on a plurality of respective tile profiles received by a master control device.

### CROSS REFERENCE TO RELATED APPLICATIONS

This application is based on and claims priority under 35 U.S.C. § 120 to U.S. Provisional Application No. 62/612,959 (“Self-Configuring Modular Surface Sensors Analytics System”) filed Jan. 2, 2018, the disclosure of which is incorporated by reference herein in its entirety.

### BACKGROUND

The present disclosure relates to sensor arrays. More specifically, the present disclosure relates to a plurality of sensors arranged on a surface.

### SUMMARY

In some embodiments, this disclosure provides a method of environmental management, including providing a self-configuring surface sensor array, receiving a first contact signal, receiving a second contact signal, generating a first path, receiving a third contact signal, receiving a fourth contact signal, generating a second path, and generating a first entity profile based, at least in part, on the first path and the second path. In some embodiments, the self-configuring surface sensor array includes a first sensor tile and a master control device. In some embodiments, the first sensor tile includes a plurality of contact sensors. In some embodiments, the first contact signal originates at a first sensor of the first plurality of contact sensors. In some embodiments, the second contact signal originates at a second sensor of the first plurality of contact sensors. In some embodiments, the first path is generated with the first contact signal and the second contact signal based, at least in part, on a temporal relationship between the first contact signal and the second contact signal, and a spatial relationship between the first sensor and the second sensor. In some embodiments, the third contact signal originates at a third sensor of the first plurality of sensors. In some embodiments, the fourth contact signal originates at a fourth sensor of the first plurality of contact sensors. In some embodiments, the second path is generated with the third contact signal and the fourth contact signal based, at least in part, on a temporal relationship between the third contact signal and the fourth contact signal, and a spatial relationship between the third sensor and the fourth sensor. In some embodiments, the first entity profile is generated based, at least in part, on the first path and the second path.

In some embodiments, the master control device is configured to releasably couple to a sensor tile, such as the first sensor tile. In some embodiments, the master control device is configured to receive a plurality of tile profiles. In some embodiments, the tile profiles include a tile identity, a tile perimeter contour, and one or more tile adjacency relationships. In some embodiments, the master control device is configured to generate a tile map based at least in part on the plurality of tile profiles. In some embodiments, the master control device is configured to generate a sensor region map based at least in part on the tile map.

In some embodiments, the method of environmental management includes receiving an external event signal. In some embodiments, the generating the first entity profile is generated based, at least in part, on the external event signal. In some embodiments, the method further includes receiving a fifth contact signal, receiving a sixth contact signal, generating a third path, receiving a seventh contact signal, receiving an eighth contact signal, generating a fourth path, and generating a second entity profile based, at least in part, on the third path path and the fourth path. In some embodiments, the fifth contact signal originates at a fifth sensor of the first plurality of contact sensors. In some embodiments, the sixth contact signal originates at a sixth sensor of the first plurality of contact sensors. In some embodiments, the third path is generated with the fifth contact signal and the sixth contact signal based, at least in part, on a temporal relationship between the fifth contact signal and the sixth contact signal, and a spatial relationship between the fifth sensor and the sixth sensor. In some embodiments, the seventh contact signal originates at a seventh sensor of the first plurality of contact sensors. In some embodiments, the eighth contact signal originates at an eighth sensor of the first plurality of contact sensors. In some embodiments, the fourth path is generated with the seventh contact signal and the eighth contact signal based, at least in part, on a temporal relationship between the seventh contact signal and the eighth contact signal, and a spatial relationship between the seventh sensor and the eighth sensor. In some embodiments, the second entity profile is generated based, at least in part, on the third path and the fourth path.

In some embodiments, the first entity profile is associated with an animate entity, such as a person or animal. In some embodiments, the method further includes transmitting an environmental control signal based, at least in part, on the first entity profile. In some embodiments, the first entity profile further includes a directed region of interest. In some embodiments, the method further includes transmitting a first environmental control signal based, at least in part, on the directed region of interest. In some embodiments, the method further includes detecting a change in an orientation of the directed region of interest, and transmitting a second environmental control signal based, at least in part, on the change in the orientation. In some embodiments, the method further includes transmitting a control signal embodying human readable instructions to an electronic device in wireless communication with the master control device.

In some embodiments, the disclosure provides a method of controlling a self-configuring sensor array, including receiving a first contact signal, receiving a second contact signal, receiving a third contact signal, receiving a fourth contact signal, generating a first path, and generating a first entity profile based, at least in part on the first path. In some embodiments, the first contact signal originates from a first contact sensor of a plurality of contact sensors. In some embodiments, the second contact signal originates from a second contact sensor of the plurality of contact sensors. In some embodiments, the third contact signal originates from a third contact sensor of the plurality of contact sensors. In some embodiments, the fourth contact sensor originates from a fourth contact sensor of the plurality of contact sensors. In some embodiments, the first path is generated with a first set of at least two contact signals. For example, the first contact signal and the third contact signal. In some embodiments, the first path is generated based, at least in part on a temporal relationship amongst the first set of contact signals, and a spatial relationship between at least two sensors corresponding to respective contact signals within the first set of contact signals. In some embodiments, the first entity profile is generated based, at least in part, on two force measurements associated with the first set of contact signals.

In some embodiments, the self-configuring sensor array includes a master control unit. In some embodiments, the master control unit is communicably connected to the plurality of contact sensors. In some embodiments, the master control unit is configured to receive a plurality of sensor profiles and generated a sensor region map based at least in part on the sensor profiles. In some embodiments, the sensor profiles include a sensor identity and one or more sensor adjacency relationships. In some embodiments, the method of controlling a self-configuring sensor array includes receiving an external event signal. In some embodiments, the the first entity profile is generated based, at least in part, on the external event signal.

In some embodiments, the method of controlling a self-configuring sensor array includes receiving a fifth contact signal, receiving a sixth contact signal, receiving a seventh contact signal, receiving an eighth contact signal, generating a second path, and generating a second entity profile based, at least in part, on the second path. In some embodiments, the fifth contact signal originates from a fifth contact sensor of the plurality of contact sensors. In some embodiments, the sixth contact signal originates from a sixth contact sensor of the plurality of contact sensors. In some embodiments, the seventh contact signal originates from a seventh contact sensor of the plurality of contact sensors. In some embodiments, the eighth contact signal originates from an eighth contact sensor of the plurality of contact sensors. In some embodiments, the second path is generated with a second set of at least two contact signals. For example, the sixth and eighth contact signals. In some embodiments, the second path is generated based, at least in part, on a temporal relationship amongst the second set of contact signals, and a spatial relationship between at least two sensors corresponding to respective contact signals within the second set of contact signals. In some embodiments, the second entity profile is based, at least in part, on the second path and at least two force measurements associated with the second set of contact signals.

In some embodiments, the first entity profile is associated with an animate entity. In some embodiments, the method of controlling a self-configuring sensor array further includes transmitting an environmental control signal based, at least in part, on the first entity profile. In some embodiments, the first entity profile further includes a directed region of interest. In some embodiments, the method of controlling a self-configuring sensor array further includes transmitting a first environmental control signal based, at least in part, on the directed region of interest. In some embodiments, the method of controlling a self-configuring sensor array further includes detecting a change in an orientation of the directed region of interest, and transmitting a second environmental control signal based, at least in part, on the change in the orientation. In some embodiments, the method of controlling a self-configuring sensor array further includes transmitting a control signal embodying human readable instructions to an electronic device in wireless communication with the master control unit.

In some embodiments, the disclosure provides a sensor array system. In some embodiments, the sensor array system includes a first sensor tile, a second sensor tile, and a master control device releasably coupled to the first sensor tile. In some embodiments, the first sensor tile includes a plurality of contact sensors. In some embodiments, the second sensor tile includes a second plurality of contact sensors. In some embodiments, the second tile is releasably coupled to the first sensor tile. In some embodiments, the master control device is configured to receive a first tile profile, receive a second tile profile, generate a tile location map, define a first sensor region, receive a first contact signal, receive a second contact signal, and generate a first entity profile. In some embodiments, the first tile profile is associated with the first sensor tile. In some embodiments, the second tile profile is associated with the second sensor tile. In some embodiments, the tile location map is generated based at least in part on the first tile profile and the second tile profile. In some embodiments, the first sensor region is defined amongst the first plurality of sensors and the second plurality of sensors. In some embodiments, the first contact signal originates at a first contact sensor in the first sensor region. In some embodiments, the second contact signal originates at a second contact sensor in the first sensor region. In some embodiments, the first entity profile is generated based, at least in part, on a temporal relationship between the first contact signal and the second contact signal, and a spatial relationship between the first contact sensor and the second contact sensor.

In some embodiments, the master control device is further configured to receive an external event signal. In some embodiments, the first entity profile is generated based, at least in part, on the external event signal. In some embodiments, the master control device is further configured to define a second sensor region, receive a third contact signal, receive a fourth contact signal, and generate a second entity profile. In some embodiments, the second sensor region is defined amongst the first plurality of sensors and the second plurality of sensors. In some embodiments, the third contact signal originates at a third contact sensor in the second sensor region. In some embodiments, the fourth contact signal originates at a fourth contact sensor in the second sensor region. In some embodiments, the second entity profile is generated based, at least in part, on a temporal relationship between the third contact signal and the fourth contact signal, and a spatial relationship between the third contact sensor and the fourth contact sensor.

In some embodiments, the first entity profile is associated with an animate entity. In some embodiments, the master control device is further configured to transmit an environmental control signal based, at least in part, on the first entity profile. In some embodiments, the first entity profile further includes a directed region of interest. In some embodiments, the master control device is further configured to transmit a first environmental control signal based, at least in part, on the directed region of interest. In some embodiments, the master control device is configured to detect a change in an orientation of the directed region of interest, and transmit a second environmental control signal based, at least in part, on the change in the orientation. In some embodiments, the master control device is configured to transmit a control signal embodying human readable instructions to an electronic device in wireless communication with the master control device.

Other aspects of the disclosure will become apparent by consideration of the detailed description and accompanying drawings.

### BRIEF DESCRIPTION OF THE DRAWINGS

FIG. 1 illustrates an exploded perspective view of a pressure sensitive tile, according to some embodiments;

FIG. 2 illustrates a sensory layer of a pressure sensitive tile, according to some embodiments;

FIG. 3 illustrates a sensory layer of a pressure sensitive tile, according to some embodiments;

FIG. 4A illustrates a first example arrangement of a sensor array, according to some embodiments;

FIG. 4B illustrates a second example arrangement of a sensor array, according to some embodiments;

FIG. 4C illustrates a third example arrangement of a sensor array, according to some embodiments;

FIG. 5 illustrates operations of a method of environmental control, according to some embodiments;

FIG. 6 illustrates operations of a method of controlling a self-configuring sensor array, according to some embodiments; and

FIG. 7 illustrates a pressure sensitive tile, according to some embodiments.

### DETAILED DESCRIPTION

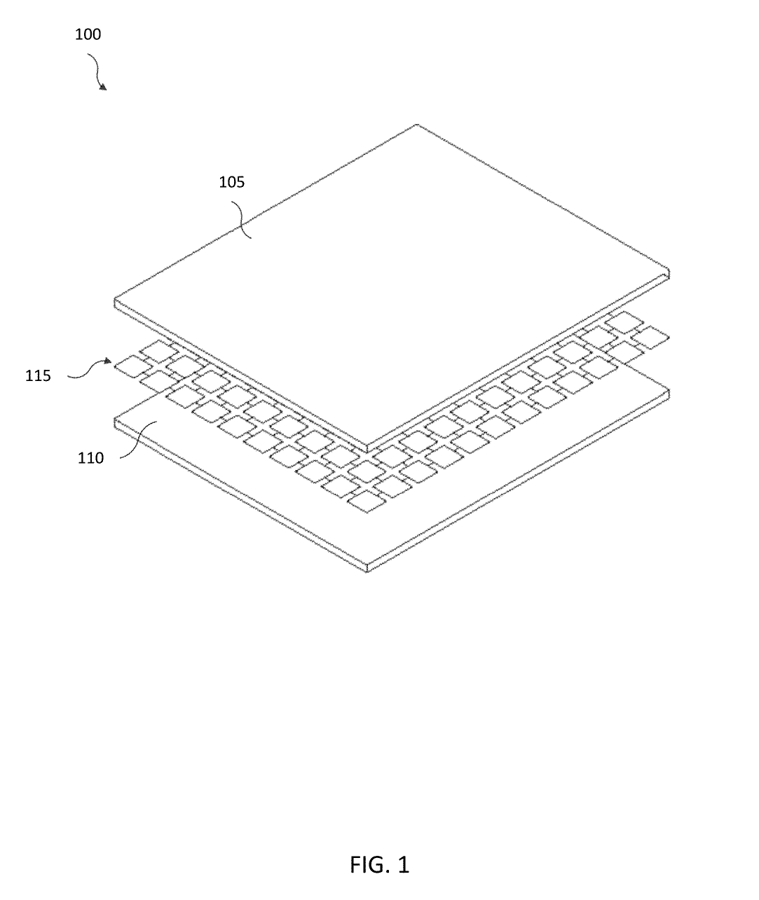

FIGS. 1 through 7, discussed below, and the various embodiments used to describe the principles of this disclosure in this patent document are by way of illustration only and should not be construed in any way to limit the scope of the disclosure.

FIG. 1 illustrates a pressure sensitive tile 100 according to certain embodiments of this disclosure. The embodiment of the pressure sensitive tile 100 shown in FIG. 1 is for illustration only and other embodiments could be used without departing from the scope of the present disclosure.

The pressure sensitive tile 100 can be any type of surface into which tactile sensors and associated leads from the contact areas to the perimeter can be integrated. In one embodiment, the pressure sensitive tile 100 is flexible, such that it can be rolled to facilitate manufacture, storage, transport, etc. In the illustrated embodiment, the pressure sensitive tile 100 is comprised of three layers: a surface layer 105, a backing layer 110, and a sensory layer 115.

In certain embodiments, the pressure sensitive tile 100 is a plastic sheet having embedded silver traces. The sensory layer 115 (i.e., the main wiring and electronics) can include the electronic traces and diodes are directly soldered onto the substrate. In certain embodiments, the switches are not electrically connected on the sensory/bottom layer (not physically connected but meshed together). In some embodiments, the second/middle layer is essentially a gap or separation layer (i.e., air) space between the sensory layer 115 and the surface layer 105. The surface layer 105 includes only the connections/electrical traces required to short-out the circuit. According to various embodiments, surface 105 and sensory 115 layers meet perpendicularly (e.g., at a 90° angle) such that there is a completed circuit allow for the flow of electrical current. When no pressure is applied, the separation layer expands and the circuit is then reopened.

In certain embodiments, the sensory layer 115 is located between the surface layer 105 and backing layers 110. In embodiments, the sensors are integrated directly on top or bottom side of the backing layer 110. Alternatively, the sensors can be added to the surface layer 105 after the surface layer 105 has been installed.

The surface layer 105 may be formed from a number of materials. Example materials for use as a surface layer 105 include, but are not limited to, any type of tile, rug, carpet, simulated wood, linoleum, rubber, tile, cork, or artificial turf Integration of the sensors is not limited to “flooring,” as the sensors could be integrated into a variety of other surfaces, including but not limited to, counter tops and walls.

Similar to the surface layer 105, any number of materials may be suitable for the backing layer 110. Example materials of the backing layer 110 include, but are not limited to, foam, insulation, vinyl, rubber, plastic, wood, fabric, and the like.

The sensory layer 115 can include a backing sheet or film 120 onto which the sensors and associated circuitry necessary for connecting to a controller 160 and network (i.e., system) are attached or integrated. In certain embodiments, the sensors are directly embedded into the backing layer 110. In various embodiments, the sensors are adhered to the film or backing sheet 120 using an adhesive (e.g., glue) prior to being integrated with the backing layer 110. In certain embodiments, the sensors and other electronic components are embedded in a protective coating 125 before being integrated with the backing layer 110.

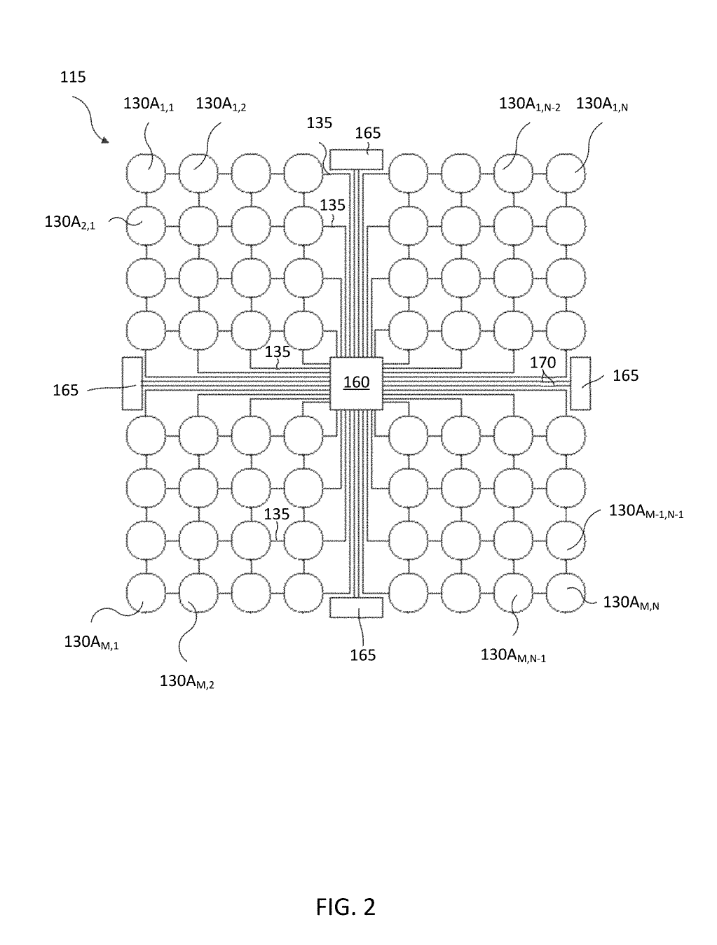

FIG. 2 illustrates an arrangement of sensors 130 in the sensory layer 115. The embodiment of the sensors 130 shown in FIG. 2 is for illustration only and other embodiments could be used without departing from the scope of the present disclosure.

Referring to the non-limiting example of FIG. 2 the sensory layer further includes the controller 160 and four communication interfaces 165. A plurality of sensor leads 135 connects the sensors 130 to the controller 160. In certain embodiments, the sensor leads 135 further interconnect the sensors 130. Network leads 170 connect the communication interfaces 165 to the controller 160. In some embodiments, the communication interfaces 165 comprise one or more exposed electrical terminals or electrical connectors, configured to mate with corresponding connectors or terminals of an adjacent tile 100. In certain embodiments, the communication interface include one or more wireless antennas configured to wirelessly communicate with an adjacent may 100, for example, over Near Field Communication (NFC).

A hard or firm backing may be present behind or under the pressure sensitive tile 100. No such covering is required on top of the pressure sensitive tile 100, but a covering (e.g., decal, sticker, carpeting, or the like) may be present. In certain embodiments the top surface covering serves as a protection; but does not distribute force between adjacent sensors. In further embodiments, the top surface covering includes a plurality of contact regions that are independently depressible.

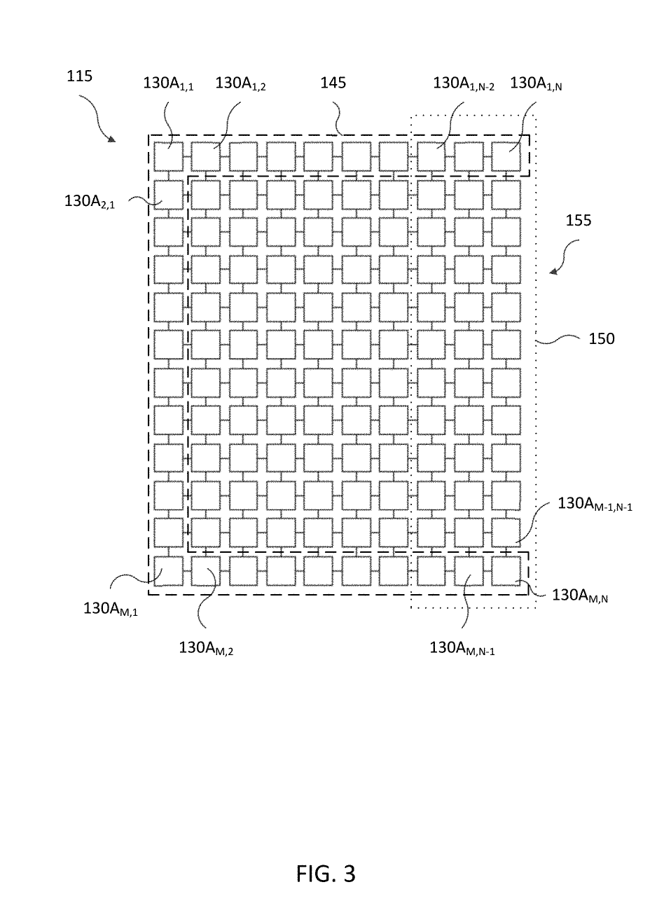

FIG. 3 illustrates an arrangement of sensors 130 in the sensory layer 115. The embodiment of the sensors 130 shown in FIG. 3 is for illustration only and other embodiments could be used without departing from the scope of the present disclosure.

The sensory layer 115 can include a plurality of sensors 130, sensor leads 135, width resistors (including indicators and wire pairs), length resistors (including indicators and wire pairs), multiplexers (or row multiplexers) and a data bus. The sensors 130 can be arranged in any suitable pattern or field, including but not limited to a grid, a rectilinear array, hexagonal, pentagonal, octagonal, etc. The sensors 130 themselves can be any suitable size and can further be spaced apart a suitable distance and arranged horizontally, vertically, or diagonally. In some embodiments, the sensory layer 115 includes a first plurality of sensors 130 and a second plurality of sensors 130, for example, pressure sensors and accelerometers. In other embodiments, sensors 130 may include Hall-effect sensors.

In some embodiments, sensors 130 are associated into zones 140, such as, for example, a boundary zone 145. In some embodiments, the sensors 130 are associated into an engagement zone 150. In some embodiments, a sensor 130 are associated with one or more zones 140. In the illustrated embodiment, the sensors 130 are numerated according to standard matrix labelling. Accordingly, the engagement zone 150 begins at a first major side 155 (i.e. sensors 130A_{1,N}-130A_{M,N}) of the pressure sensitive tile 100 and extends away from the first major side 155 (e.g. including sensors 130A_{1,N-2}-130A_{M,N-1}). In the illustrated embodiment, the boundary zone 145 includes the outermost sensors 130 of three sides of the tile 100 (i.e. the set of sensors {{130A_{1,1}-130A_{1,N}},{130A_{M,2}-130A_{M,N}},{130A_{2,1}-130A_{M,1}}}). However, the boundary zone 145 may include more or fewer sensors 130, for example, only the sensors 130 of the sides of the tile 100 adjacent the major side 155.

In some embodiments, one or more zones 140 are partially coextensive or overlapping. In some embodiments, one or more zones 140 include sensors from more than one tile 100. Accordingly, a plurality of zones 140 may be located or dimensioned across areas beyond the dimensions of a single tile (such as tile 100). Further, in some embodiments, a zone 140 may be resized based, at least in part, on a contact signal. For example, an engagement zone 150 may be defined as beginning at the first major side 155 of the tile 100 and extending away an initial distance, for example two columns of sensors 130. An object placed on the tile 100 within the engagement zone would cause one or more contact sensors 130 to transmit a contact signal. Additionally, the object may impede movement in the engagement zone 150. Accordingly, a person trying to stand in or pass through the engagement zone 150 may be forced to stand or pass further from the first major side 155. Accordingly, the engagement zone 150 may be increased.

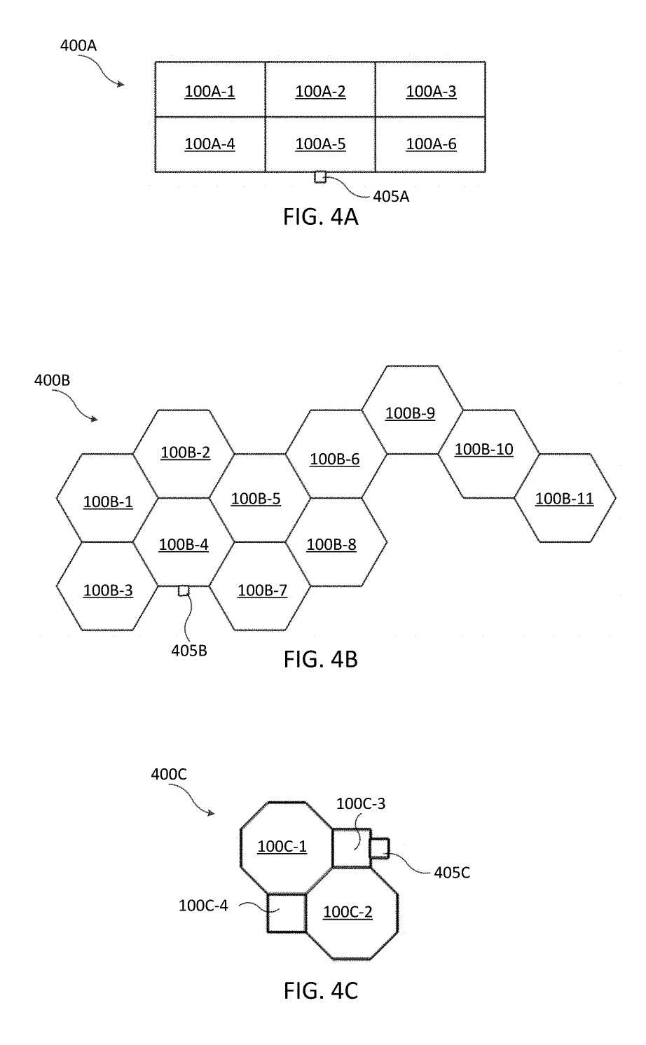

FIGS. 4A-4C illustrate arrangements of a self-configuring sensor array 400. The embodiment of the self-configuring sensor array 400 shown in FIGS. 4A-4C is for illustration only and other embodiments could be used without departing from the scope of the present disclosure.

Each array includes at least one pressure sensitive tile (for example, tile 100) and a master control device 405 releasably coupled to the pressure sensitive tile 100. For example, the master control device 405 may include one or more electrical terminals or connectors to electrically couple to the tile 100, for example, at a communication interface 165. Alternatively, or in addition, the master control device 405 may include one or more antennas configured to wirelessly couple the master control device 405 to the tile 100. Accordingly, the master control device 405 may be releasably coupled, for example, with a mechanical or magnetic connection.

FIG. 4A illustrates a first arrangement of a self-configuring sensor array 400A, also called a rectangular array. The embodiment of the self-configuring sensor array 400A shown in FIG. 4A is for illustration only and other embodiments could be used without departing from the scope of the present disclosure.

The illustrated array 400a includes six rectangular pressure sensitive tiles (numbered 100A-1 through 100A-6, and collectively “100A”) in communication with respectively adjacent tiles 100A over respective communication interfaces, such as communications interface 165. The master control device 405A is releasably coupled to a first tile 100A-5. Accordingly, the master control device 405A may receive contact signals originating in any of the tiles 100A. Further, the master control device 405A may receive a tile profile of a tile 100A. For example, the master control device 405A may receive a tile profile including a tile identity, a tile perimeter contour, and one or more tile adjacency relationships. In the illustrated embodiment, a tile profile of the first tile 100A-5 includes an identity, such as a MAC address, a tile perimeter contour, such as the dimensions of respective sides and angles therebetween, and tile adjacency relationships, such as a direct adjacency (e.g. 4-connected neighborhood) to tiles 100A-4, 100A-2, and 100A-6, and indirect adjacency (e.g. 8-connected neighborhood) to tiles 100A-1 and 100A-3. The master control device 405A may then generate a tile map based, at least in part, on the tile profiles received from the tiles 100A-1-100A-6. Further, the master control device 405A may generate a sensor region map based at least in part on the tile map. For example, the master control device 405A may define an engagement zone (e.g. engagement zone 150 of FIG. 3) amongst the sensors of tiles 100A-4, 100A-5, and 100A-6.

FIG. 4B illustrates a second arrangement of a self-configuring sensor array 400B, also called a hexagonal array. The embodiment of the self-configuring sensor array 400B shown in FIG. 4B is for illustration only and other embodiments could be used without departing from the scope of the present disclosure.

The illustrated array 400B includes a plurality of pressure sensitive tiles 100B distributed in an asymmetrical arrangement. In some embodiments, the master control device 405B is impartial to the arrangement of tiles 100B. Accordingly, tiles 100B may be arranged in any suitable arrangement, for example, in a shopping aisle, office corridor, or stadium entrance. In some embodiments, the master control device 405B may be releasably coupled to any of the tiles 100B. In some embodiments, the master control device 405B is located, or disposed, in an easily accessible location. In certain embodiments, the master control device 405B is located, or disposed, away from a high-traffic area. Accordingly, the master control device 405B may be releasably de-coupled from the pressure sensitive tile 100B-4 and re-coupled to any of the other tiles 100B. In some embodiments, the master control device 405B may retain a tile map or sensor map after de-coupling. In other embodiments, the master control device 405B may generate one or both of the tile map and sensor map after re-coupling to a tile 100B.

FIG. 4C illustrates a third arrangement of a self-configuring sensor array 400C, which includes tiles 100C having different perimeter contours. The embodiment of the self-configuring sensor array 400C shown in FIG. 4C is for illustration only and other embodiments could be used without departing from the scope of the present disclosure.

Unlike the rectangular and hexagonal arrays, the array 400C includes a pair of octagonal tiles 100C-1 and 100C-2 and a pair of square tiles 100C-3 and 100C-4. Accordingly, an array may include a plurality of tiles, including non-uniform tiles. In certain embodiments, the tiles 100 are configured for easily tessellation (but this may not be required). For example, a flexible or expandable tile (for example, tile 100) may have a different shape than a second, adjacent, tile 100. Accordingly, the master control device 405C can generate one or both of a new tile map and sensor map intermittently or periodically. For example, a plurality of flexible tiles (including tile 100) may be coupled together into a sensor array 400. The master control device 405, coupled to one of the flexible tiles (for example, tile 100), may generate a sensor map in response to the array 400 being deformed or reshaped. Similarly, the master control device 405 can generate one, or both, of the tile map and the sensor map in response to one or more tiles being added, removed, or repositioned.

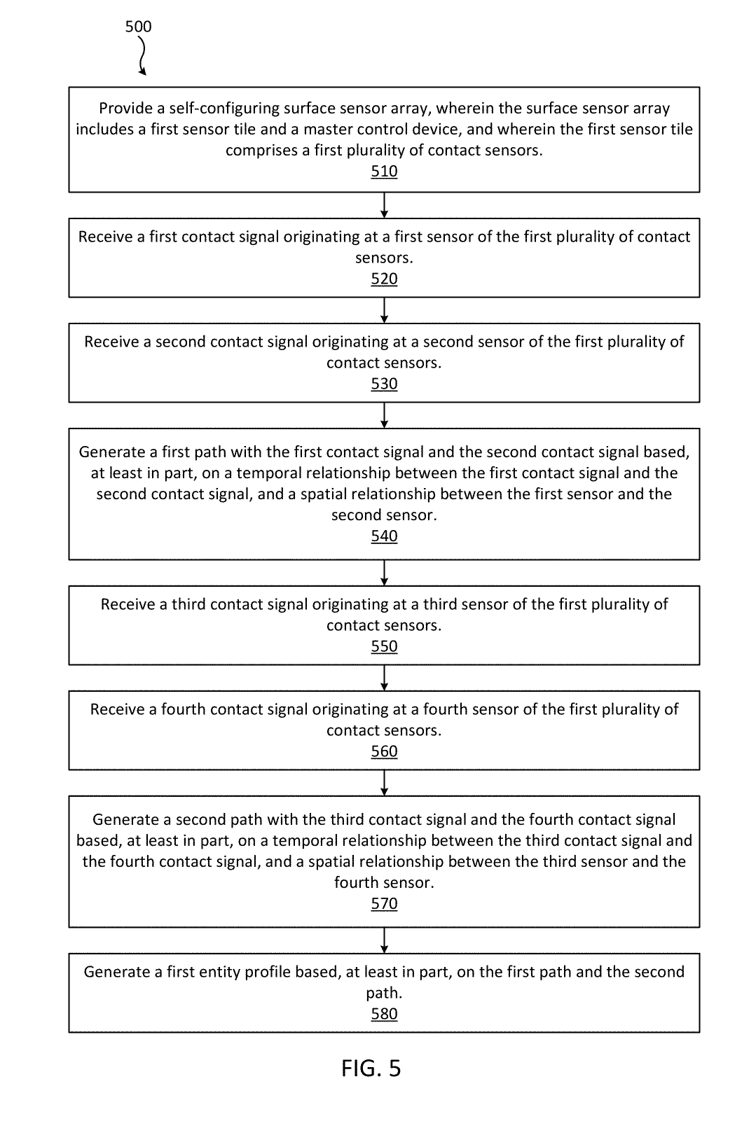

FIG. 5 illustrates a flow diagram of a method 500 of environmental management according to various embodiments of this disclosure. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps.

In block 510, a self-configuring surface sensor array is provided. The surface sensor array includes a first sensor tile and a master control device. The first sensor tile includes a first plurality of contact sensors. In block 520, a first contact signal, originating at a first sensor of the first plurality of contact sensors, is received. In block 530, a second contact signal, originating at a second sensor of the first plurality of contact sensors is received. In block 540, a first path is generated with the first contact signal and the second contact signal. The generation of the first path is based, at least in part, on a temporal relationship between the first contact signal and the second contact signal. For example, a temporal relationship may include a timestamp of the respective signal. In some embodiments, a temporal relationship includes one or more compensating factors for propagation delay. The generation of the first path is further based, at least in part, on a spatial relationship between the first sensor and the second sensor. For example, a distance or relative positioning between sensors.

In block 550, a third contact signal, originating at a third sensor of the first plurality of contact sensors, is received. In block 560, a fourth contact signal, originating at a fourth sensor of the first plurality of contact sensors, is received. In block 570, a second path is generated with the third contact signal and the fourth contact signal. The generation of the second path is based, at least in part, on a temporal relationship between the third contact signal and the fourth contact signal. The generation of the second path is further based, at least in part, on a spatial relationship between the third sensor and the fourth sensor.

In block 580, a first entity profile is generated based, at least in part, on the first path and the second path. For example, the first path and second path may be static paths, and the contact signals of the first and second paths may include constant force or pressure signals. Accordingly, a first entity profile may be generated corresponding to an inanimate object, such as a box or pallet. Similarly, in the cased that the first path and the second path are dynamic paths, the first entity profile may be generated corresponding to an animate object, such as a human or animal. Further, characteristics of the first and second paths may provide varying degrees of granularity in the received contact signals. For example, a human adult tends to have a higher weight, longer stride, and larger footprint than a human child. Accordingly, the entity profile may further be associated with an adult or child.

A human gait includes a plurality of characteristics, such as stride length, cadence, speed, progression line, foot angle, hip angle, etc. Accordingly, the first and second paths may be used to generate an entity profile associated with particular sexes, weights, heights, ages, emotions, injuries, or disorders. Further, the entity profile may be associated with a real-time directed region of interest. For example, humans have approximately a 210° horizontal visual field. Accordingly, an entity profile associated with a human may further be associated with a directed region of interest in a direction of travel, or in a most recent direction of travel, for example, along the first or second paths. Alternatively, or in addition, the directed region of interest may be modified based, at least in part, on one or more gait characteristics. For example, a vertically directed region of interest may be reduced for an entity profile associated with a child. As another example, a directed region of interest may be shifted based, at least in part, on a shift in direction of travel.

In certain embodiments, the master control device of the method 500 is configured to releasably couple to a sensor tile, such as the first sensor tile. In some embodiments, the master control device is further configured to receive a plurality of tile profiles including, for example, a tile identity, a tile perimeter contour, and one or more tile adjacency relationships. In some embodiments, the master control device is configured to generate a tile map based, at least in part, on the plurality of tile profiles. In some embodiments, the master control device is configured to generate a sensor region map based, at least in part, on the tile map.

In some embodiments, the method 500 further includes receiving an external event signal. In some embodiments, the generating the first entity profile is generated based, at least in part, on the external event signal. For example, a wireless transmission, such as a text message or “tweet”, may be received from a portable electronic device, such as a smartphone. The first entity profile may then be generated based, at least in part, on the external event signal. For example, children and animals rarely communicate via smartphone. Conversely, many smart devices, such as Internet-of-Things devices, lightbulbs, and other network actors regularly transmit event signals. Further, the first entity profile may be generated based, at least in part, on a quantity or frequency of external event signals.

In some embodiments, the method 500 further includes receiving a fifth contact signal originating at a fifth sensor of the first plurality of contact sensors and receiving a sixth contact signal originating at a sixth sensor of the first plurality of contact sensors. The method 500 may further include generating a third path with the fifth contact signal and the sixth contact signal. The generation of the third path is based, at least in part, on a temporal relationship between the fifth contact signal and the sixth contact signal. The generation of the third path is further based, at least in part, on a spatial relationship between the fifth sensor and the sixth sensor. In some embodiments, the method 500 further includes receiving a seventh contact signal originating at a seventh sensor of the first plurality of contact sensors and receiving an eighth contact signal originating at an eighth sensor of the first plurality of contact sensors. The method 500 may further include generating a fourth path with the seventh contact signal and the eighth contact signal. The generation of the fourth path is based, at least in part, on a temporal relationship between the seventh contact signal and the eighth contact signal. The generation of the fourth path is further based, at least in part, on a spatial relationship between the seventh sensor and the eighth sensor. In some embodiments, the method 500 includes generating a second entity profile based, at least in part, on the fifth path and the sixth path.

In some embodiments, the method 500 further includes, in the case where the first entity profile is associated with an animate entity, transmitting an environmental control signal based, at least in part, on the first entity profile. For example, an entity profile associated with a customer may trigger the master control device to transmit an environmental control signal to a light controller to adjust a light level. In other embodiments, in the case where the first entity profile is associated with an entity less dependent upon light than a human, the master control device may not transmit the environmental control signal to the light controller.

Further, an environmental control signal may be transmitted iteratively. For example, a first environmental control signal may be transmitted based, at least in part, on the directed region of interest. A change in an orientation of the directed region of interested is then detected, and a second environmental control signal is transmitted based, at least in part, on the change in the orientation. For example, a lighting system may be controlled to selectively illuminate a directed region of interest of a user, or illuminate the direction region of interest at a higher luminosity. Accordingly, improved energy efficiency may be achieved. Beyond energy efficiency, environmental control signals may be used to improve utilization of space. Current building management systems may rely on rudimentary control schemes, such as developing positive atmospheric pressure to keep out insects. However, other entities respond to stimuli as well. For example, warmer or cooler regions of a building may attract or dissuade customers, brighter or dimmer regions may inform tourist wayfinding, warmer or cooler color temperature may influence human appetite, and an increased volume or sound pressure level may improve foot traffic throughput. Further, one or more of these stimuli may constructively or destructively interfere with one or more of the other stimuli, or generate a synergistic effect.

In some embodiments, the method 500 includes transmitting a control signal embodying human readable instructions to an electronic device in wireless communication with the master control device, for example, over a Wireless Local Area Network (WLAN). For example, the master control device may detect that a customer has been standing in an engagement zone and observing a product display. The master control device may then send a message to an employee's smartphone, including instructions to seek out the customer.

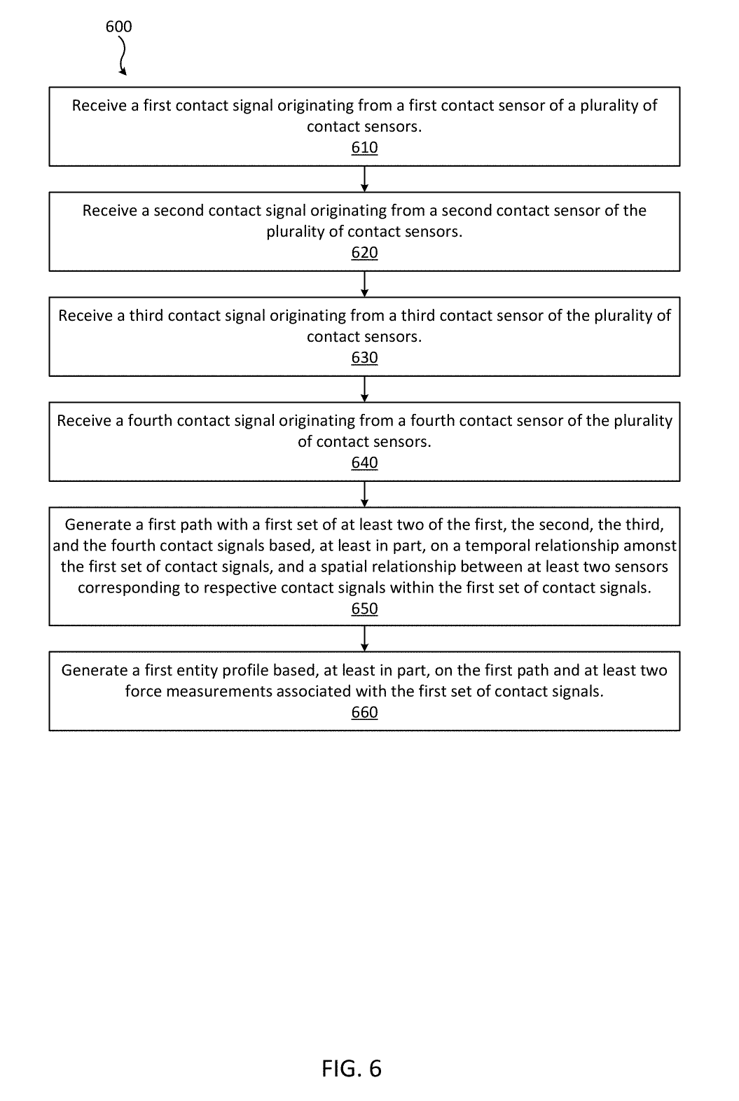

FIG. 6 illustrates operations of a method 600 of controlling a self-configuring sensor array, according to some embodiments. While the flow chart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps.

In block 610, a first contact signal is received, the first contact signal originating from a first contact sensor of a plurality of contact sensors. In block 620, a second contact signal is received, the second contact signal originating from a second contact sensor of the plurality of contact sensors. In block 630, a third contact signal is received, the third contact signal originating from a third contact sensor of the plurality of contact sensors. In block 640, a fourth contact signal is received, the fourth contact signal originating from a fourth contact sensor of the plurality of contact sensors. In block 650, a first path is generated with a first set of contact signals. In some embodiments, the first set includes at least two of the first contact signal, the second contact signal, the third contact signal, and the fourth contact signal. The generation of the first path is based, at least in part, on a temporal relationship amongst the first set of contact signals. The generation of the first path is further based, at least in part, on a spatial relationship between at least two sensors corresponding to respective contact signals within the first set of contact signals. In block 660, a first entity profile is generated based, at least in part, on the first path and at least two force measurements associated with the first set of contact signals.

In some embodiments, the self-configuring sensor array of the method 600 includes a master control unit communicably connected to the plurality of contact sensors. The master control unit is configured to receive a plurality of sensor profiles associated with respective contact sensors. In some embodiments, a sensor profile includes a sensor identity and one or more sensor adjacency relationships. In some embodiments, the master control unit is configured to generate a sensor region map based at least in part on the sensor profiles.

In some embodiments, the method 600 further includes receiving an external event signal. In some embodiments, the generating the first entity profile is generated based, at least in part, on the external event signal.

In some embodiments, the method 600 further includes receiving a fifth contact signal, the fifth contact signal originating from a fifth contact sensor of the plurality of contact sensors. In some embodiments, the method 600 further includes receiving a sixth contact signal, the sixth contact signal originating from a sixth contact sensor of the plurality of contact sensors. In some embodiments, the method 600 further includes receiving a seventh contact signal, the seventh contact signal originating from a seventh contact sensor of the plurality of contact sensors. In some embodiments, the method 600 further includes receiving an eighth contact signal, the eighth contact signal originating from an eighth contact sensor of the plurality of contact sensors. In some embodiments, a second path is generated with a second set of contact signals. In some embodiments, the second set includes at least two of the fifth contact signal, the sixth contact signal, the seventh contact signal, and the eighth contact signal. The generation of the second path is based, at least in part, on a temporal relationship amongst the second set of contact signals. The generation of the second path is further based, at least in part, on a spatial relationship between at least two sensors corresponding to respective contact signals within the second set of contact signals. In some embodiments, a second entity profile is generated based, at least in part, on the first path and at least two force measurements associated with the second set of contact signals.

In some embodiments, the first entity profile is associated with an animate entity, such as a person or animal. In some embodiments, the method 600 further includes transmitting an environmental control signal based, at least in part, on the first entity profile. In some embodiments, the first entity profile includes a directed region of interest. In some embodiments, the method 600 further includes transmitting a first environmental control signal based, at least in part, on the directed region of interest, detecting a change in an orientation of the directed region of interest, and transmitting a second environmental control signal based, at least in part, on the change in the orientation. In some embodiments, the method 600 further includes transmitting a control signal embodying human readable instructions to an electronic device in wireless communication with the master control unit.

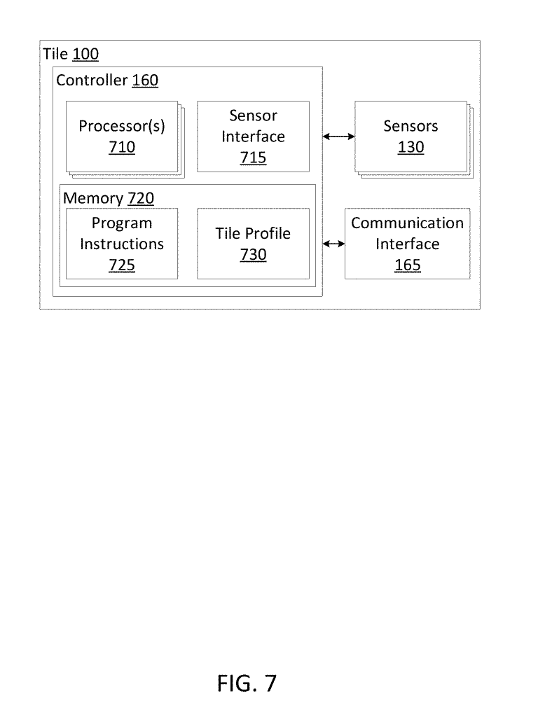

FIG. 7 illustrates a pressure sensitive tile 100, including the controller 160, the sensors 130, and the communication interface 165. The embodiment of the pressure sensitive tile 100 shown in FIG. 7 is for illustration only and other embodiments could be used without departing from the scope of the present disclosure.

In some embodiments, the controller 160 includes one or more processors 710 and a sensor interface 715. In some embodiments, the sensor interface includes circuitry configured to electrically couple the sensors 130 to the one or more processors 710. In some embodiments, the controller 160 further includes a memory 720 storing program instructions 725 executable by the one or more processors 710 to implement any of the functionality described herein. In some embodiments, the memory 720 may further include a tile profile 730 associated with the tile 100.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Various features and advantages of the disclosure are set forth in the following claims.

What is claimed is:

1. A method of environmental management, comprising:
receiving, at a self-configuring surface sensor array, the self-configuring surface sensor array comprising a first sensor tile and a master control device, the first sensor tile further comprising a first plurality of contact sensors, a first contact signal originating at a first sensor of the first plurality of contact sensors;
receiving a second contact signal from a second sensor of the first plurality of contact sensors;
generating a first path with the first contact signal and the second contact signal based on a temporal relationship between the first contact signal and the second contact signal, and a spatial relationship between the first sensor and the second sensor;
receiving a third contact signal from a third sensor of the first plurality of contact sensors;
receiving a fourth contact signal originating at a fourth sensor of the first plurality of contact sensors;
generating a second path with the third contact signal and the fourth contact signal based on a temporal relationship between the third contact signal and the fourth contact signal, and a spatial relationship between the third sensor and the fourth sensor; and
generating a first entity profile based on the first path and the second path.

2. The method of claim 1, wherein the master control device is configured to:
releasably couple to a sensor tile;
receive a plurality of tile profiles, the tile profiles comprising:
a tile identity;
a tile perimeter contour; and
one or more tile adjacency relationships;
generate a tile map based at least in part on the plurality of tile profiles; and
generate a sensor region map based at least in part on the tile map.

3. The method of claim 1, further comprising:
receiving an external event signal,
wherein the first entity profile is generated based on the external event signal.

4. The method of claim 1, further comprising:
receiving a fifth contact signal from a fifth sensor of the first plurality of contact sensors;
receiving a sixth contact signal from a sixth sensor of the first plurality of contact sensors;
generating a third path with the fifth contact signal and the sixth contact signal based on a temporal relationship between the fifth contact signal and the sixth contact signal, and a spatial relationship between the fifth sensor and the sixth sensor;
receiving a seventh contact signal from a seventh sensor of the first plurality of contact sensors;
receiving an eighth contact signal from an eighth sensor of the first plurality of contact sensors;
generating a fourth path with the seventh contact signal and the eighth contact signal based on a temporal relationship between the seventh contact signal and the eighth contact signal, and a spatial relationship between the seventh sensor and the eighth sensor; and
generating a second entity profile based on the third path and the fourth path.

5. The method of claim 1, further comprising:
transmitting an environmental control signal based on the first entity profile.

6. The method of claim 1, wherein the first entity profile further comprises a directed region of interest, and wherein the method further comprises:
transmitting a first environmental control signal based on the directed region of interest;
detecting a change in an orientation of the directed region of interest; and
transmitting a second environmental control signal based on the change in the orientation.

7. The method of claim 1, further comprising:
transmitting a control signal embodying human readable instructions to an electronic device in wireless communication with the master control device.

8. A method of controlling a self-configuring sensor array, the method comprising:
receiving a first contact signal from a first contact sensor of a plurality of contact sensors;
receiving a second contact signal from a second contact sensor of the plurality of contact sensors;
receiving a third contact signal from a third contact sensor of the plurality of contact sensors;
receiving a fourth contact signal from a fourth contact sensor of the plurality of contact sensors;
generating a first path with a first set of contact signals of least two of the first contact signal, the second contact signal, the third contact signal, or the fourth contact signal, based on a temporal relationship between the first set of contact signals and a spatial relationship between at least two sensors corresponding to respective contact signals within the first set of contact signals; and
generating a first entity profile based on the first path and at least two force measurements associated with the first set of contact signals.

9. The method of claim 8, wherein the self-configuring sensor array comprises a master control unit communicably connected to with the plurality of contact sensors, and wherein the master control unit is configured to:
receive a plurality of sensor profiles, each sensor profiles comprising:
a sensor identity; and
one or more sensor adjacency relationships associated with the sensor identity; and
generate a sensor region map based at least in part on the sensor profiles.

10. The method of claim 8, further comprising:
receiving an external event signal; and
generating the first entity profile on the external event signal.

11. The method of claim 8, further comprising:
receiving a fifth contact signal from a fifth contact sensor of the plurality of contact sensors;
receiving a sixth contact signal from a sixth contact sensor of the plurality of contact sensors;
receiving a seventh contact signal from a seventh contact sensor of the plurality of contact sensors;
receiving an eighth contact signal from an eighth contact sensor of the plurality of contact sensors;
generating a second path with a second set of contact signals of least two of the fifth contact signal, the sixth contact signal, the seventh contact signal, or the eighth contact signal based on a temporal relationship amongst the second set of contact signals, and a spatial relationship between at least two sensors corresponding to respective contact signals within the second set of contact signals; and
generating a second entity profile based on the second path and at least two force measurements associated with the second set of contact signals.

12. The method of claim 8, wherein the method further comprises:
transmitting an environmental control signal based on the first entity profile.

13. The method of claim 8, wherein the first entity profile further comprises a directed region of interest, and wherein the method further comprises:
transmitting a first environmental control signal based on the directed region of interest;
detecting a change in an orientation of the directed region of interest; and
transmitting a second environmental control signal based on the change in the orientation.

14. The method of claim 8, further comprising:
transmitting a control signal embodying human readable instructions to an electronic device in wireless communication with a master control unit.

15. A sensor array system, comprising:
a first sensor tile including a first plurality of contact sensors;
a second sensor tile including a second plurality of contact sensors, the second sensor tile releasably coupled to the first sensor tile;
a master control device releasably coupled to the first sensor tile, wherein the master control device is configured to:
receive a first tile profile associated with the first sensor tile;
receive a second tile profile associated with the second sensor tile;
generate a tile location map based at least in part on the first tile profile and second tile profile;
define a first sensor region amongst the first plurality of contact sensors and the second plurality of contact sensors;
receive a first contact signal originating at a first contact sensor in the first sensor region;
receive a second contact signal originating at a second contact sensor in the first sensor region; and
generate a first entity profile based, at least in part, on a temporal relationship between the first contact signal and the second contact signal, and a spatial relationship between the first contact sensor and the second contact sensor.

16. The sensor array system of claim 15, wherein the master control device is further configured to:
receive an external event signal, and
generate the first entity profile based on the external event signal.

17. The sensor array system of claim 15, wherein the master control device is further configured to:
define a second sensor region amongst the first plurality of contact sensors and the second plurality of contact sensors;
receive a third contact signal originating at a third contact sensor in the second sensor region;
receive a fourth contact signal originating at a fourth contact sensor in the second sensor region; and
generate a second entity profile based, at least in part, on a temporal relationship between the third contact signal and the fourth contact signal, and a spatial relationship between the third contact sensor and the fourth contact sensor.

18. The system of claim 15, wherein the master control device is further configured to:
transmit an environmental control signal based on the first entity profile.

19. The sensor array system of claim 15, wherein the first entity profile further comprises a directed region of interest, and wherein the master control device is further configured to:
transmit a first environmental control signal based on the directed region of interest;
detect a change in an orientation of the directed region of interest; and
transmit a second environmental control signal based on the change in the orientation.

20. The sensor array system of claim 15, wherein the master control device is further configured to:
transmit a control signal embodying human readable instructions to an electronic device in wireless communication with the master control device.
